(19) United States
(12) Patent Application Publication
(10) Pub. No.: US 2005/0134248 A1
(43) Pub. Date: Jun. 23, 2005

(54) Methods and systems for load bank control and operation

(76) Inventors: Anthony S. Locker, Cincinnati, OH (US); William T. Brungs, North Bend, OH (US)

Correspondence Address: DINSMORE & SHOHL, LLP, 1900 CHEMED CENTER, 255 EAST FIFTH STREET, CINCINNATI, OH, 45202, US

(21) Appl. No.: 10/994,909

(22) Filed: Nov. 22, 2004

Related U.S. Application Data
(60) Provisional application No. 60/524,167, filed on Nov. 21, 2003.

(51) Int. Cl. G05F 1/40

(52) U.S. Cl. 323/285

(57) ABSTRACT

An improved load bank system is provided. In one embodiment, the system includes control circuitry configured to provide duty cycle commands corresponding to a desired load. An input is configured to receive power from an electrical power system to be connected to the load bank system. At least one power resistor is selectively connected to the input. High speed solid state electronic switching circuitry is configured to rapidly switch according to the duty cycle command from the control circuitry in order to rapidly and sequentially permit current flow and prevent current flow through the resistor according to the duty cycle command. The effective resistance presented to an electrical power system to be connected at the input is thereby modified. Other load bank systems and load bank units are provided, as well as computer implemented and other methods for controlling a load bank system.

### CROSS-REFERENCE TO RELATED APPLICATION

This application claims the benefit of U.S. Provisional Application No. 60/524,167, filed Nov. 21, 2003, the entire disclosure of which is hereby incorporated herein by reference.

### TECHNICAL FIELD

The present invention relates generally to methods and systems for load bank control and operation. In particular, embodiments of the present invention relate to such methods and systems that include programmable digital electronics for defining a testing profile to mimic actual operational parameters, high speed switching electronics for substantially infinite variability of load conditions, local and remote operation through computer network connectivity, and control capability from auxiliary devices.

### BACKGROUND OF THE INVENTION

A load bank is a testing device that sets a desired electrical load which is then applied to an electrical power source (e.g., an emergency backup generator), so as to mimic or synthesize the operational load that will be applied to the power source during actual operation. The load bank then converts and dissipates the resultant power output of the power source, just as would the real load during operation. However, rather than being unpredictable and random in value as would be the actual load during operation, the load bank provides an organized and controllable load that can be used for testing, optimizing, and exercising power sources, such as generators and uninterruptible power supplies, under varying conditions and parameters. Such testing is needed, and often required, in order to ensure that the electrical power system will operate as intended under actual load, and for periodic testing and maintenance of the equipment to ensure proper operation.

A load bank may be permanently installed as an integral component of an electrical power system, or may be portable and connected to various systems when needed. The “load” of a resistive load bank can be created by power resistors which dissipate the electrical energy from the source as heat. The resistance of the load can be set to the resistance expected to be encountered during actual operation. For example, the resistance can be set to mimic the load of lighting systems, electrical heaters, motors, computers, and other electrical devices that would be connected to the source during actual operation.

However, conventional load banks can suffer from a number of disadvantages. First, adjusting the load that a conventional load bank places upon a connected source (e.g., a generator) can be time consuming, tedious, and inaccurate, as such changes often involve the physical insertion or extraction of one or more resistors into an existing resistor network. Hence, such load banks typically require changing a load in steps and therefore are limited as to the type of load changes that can be made during the testing procedure as well as the amount of load that can be changed. In addition, while controls can be provided for configuring the load bank to the appropriate load, there is typically little or no ability to provide other control inputs to a conventional load bank from auxiliary controls or other ancillary automation equipment. Also, many such load banks are not easily modified to operate with external equipment, and further are not easily upgraded (e.g., to include additional or fewer resistors). In addition, many conventional load bank systems are costly, unreliable, and exhibit inadequate performance.

Accordingly, there is a need for improved methods and systems for load bank control and operation.

### SUMMARY OF THE INVENTION

Accordingly, it is desired to provide improved methods and systems for load bank control and operation.

According to one aspect, a load bank system includes control circuitry configured to provide duty cycle commands corresponding to a desired load. An input is configured to receive power from an electrical power system to be connected to the load bank system. At least one power resistor is selectively connected to the input. High speed solid state electronic switching circuitry is configured to rapidly switch according to the duty cycle commands from the control circuitry in order to rapidly and sequentially permit full current flow and prevent current flow through the resistor according to the duty cycle commands. The effective resistance presented to an electrical power system to be connected at the input is thereby modified.

According to another aspect, the high-speed solid state electronic switching circuitry includes at least one IGBT transistor, the control circuitry includes a programmable HMI unit, and the load bank system further includes a microprocessor for providing control signals to the IBGT transistor according to the duty cycle commands.

According to yet another aspect, the programmable HMI unit includes a display and input devices. A program in the HMI unit allows a user to program a load profile to be presented by the load bank over time. The electronic switching circuitry allows for a substantially infinite number of duty cycles and corresponding effective resistances. The HMI unit includes a communication circuit for communicating with additional digital computing devices. The load bank is configured to allow for duty cycle commands from devices other than the HMI unit.

According to still another aspect, a computer implemented method for controlling and operating a load bank system is provided using executable instructions. The method includes receiving configuration parameters for the load bank and receiving an input indicating whether an automatic or manual mode of operation is desired. If a manual mode input is received, a modification is allowed of the desired power dissipation through the load bank. In such a situation, the effective resistance of the load bank is maintained indefinitely according to the desired power output until another modification of the desired power dissipation is received from the user. If an automatic mode input is received, the user is allowed to configure a power profile indicative of the desired power dissipation through the load bank at multiple points in time. In this situation, the effective resistance of the load bank is changed at various points in time according to the power profile. In one specific embodiment of the invention, the effective resistance is maintained and changed by adjusting a duty cycle command.

According to another aspect, a method for controlling and operating a load bank system is provided. The method includes receiving a desired power dissipation value from a user and providing a duty cycle command based upon the desired power dissipation value. An electronic switch is rapidly switched according to the duty cycle in order to rapidly and sequentially permit full current flow and prevent current flow through the power resistors of a load according to the duty cycle represented by the command. The effective resistance presented to an electrical power source connected to the load bank is thereby modified.

According to still another aspect, a load bank unit includes an input for receiving a duty cycle command signal from a programmable controller. The load bank further includes an HMI communication circuit for communication between the load bank power electronics and a human machine interface terminal. A power input receives power from an electrical power system to be connected to the load bank system. At least one power resistor is configured to be connected to an electrical power system to be tested by the load bank unit. High speed solid state electronic switching is configured to rapidly switch according to the duty cycle command signal from the programmable controller in order to rapidly and sequentially permit current flow and prevent current flow through the resistor according to the duty cycle represented by the duty cycle command signal. The effective resistance presented to the electrical power system is thereby modified.

According to yet another aspect, a computer implemented method for controlling and operating a load bank system utilizing executable instructions is provided. The method includes receiving an input indicating whether a remote or a local mode of operation is desired. If the local mode is desired, a modification is received of the desired power dissipation through the load bank from a human machine interface unit, and current flow through the load bank power resistors is changed based upon the modification. If the remote mode is desired, a modification of the desired power dissipation through the load bank is permitted from an auxiliary controller unit, and the current flow through the load bank power resistors is changed based upon the modification. In one exemplary embodiment of the invention, the method includes monitoring actual power dissipation and changing the current flow through the load bank power resistors based upon the difference between the actual power dissipation and the desired power dissipation.

According to still another embodiment of the invention, a load bank system includes control circuitry configured to provide duty cycle commands corresponding to a desired load. An input is configured to receive power from an electrical power system to be connected to the load bank system. At least one power resistor is provided for selective connection to the input. High speed solid state electronic switching circuitry is configured to rapidly connect and disconnect the resistor to the input according to the duty cycle commands from the control circuitry. Power consumption by the resistor from an electrical power system to be connected at the input is thereby precisely regulated.

Still other aspects will become apparent to those skilled in the art from the following description wherein there are shown and described alternative illustrative embodiments. These embodiments and descriptions are provided only as illustrative examples, and in no way are intended, nor should they be interpreted, as limiting. As will be realized, other different embodiments are possible without departing from the inventive principles. These other possible embodiments will be understood by those skilled in the art based upon the description and teachings herein. Accordingly, the drawings and descriptions provided herein should be regarded as illustrative and exemplary in nature only, and not as restrictive.

### BRIEF DESCRIPTION OF THE DRAWINGS

It is believed that the present invention will be better understood from the following description taken in conjunction with the accompanying drawings in which:

FIG. 1 is a front perspective view of one illustrative embodiment of a load bank, along with its associated HMI programming and control unit, which are made and operate in accordance with principles of the present invention;

FIG. 2 is a front perspective view of another embodiment of a load bank system made and operating in accordance with principles of the present invention, wherein the HMI programming and control unit are integrated with the load bank unit;

FIG. 3a is a schematic diagram of an embodiment of a load bank having an infinitely variable load, along with its HMI programming and control unit, which are made and operate according to principles of the present invention;

FIGS. 3b-3g are electrical schematic diagrams illustrating various examples of high speed switching circuits that can be utilized with the embodiments of FIGS. 3a and 4 to electronically vary the effective load to any of a substantially infinite number of values and with any of various transition functions desired, according to principles of the present invention;

FIG. 4 is a diagram illustrating another embodiment of a load bank system made and operating according to principles of the present invention;

FIGS. 5a-5f are plots of the various electrical voltages and currents that can be provided to the power resisters in the embodiment of FIG. 4, by varying the load current utilizing electronic switching via the electronic controller;

FIG. 6 is a flow diagram illustrating a software routine which may be operated by a load bank HMI control unit, according to principles of the present invention; and

FIG. 7 is a schematic diagram illustrating an embodiment of a high speed switching circuit that can be utilized to electronically vary the effective load presented by load bank resistors to any of a substantially infinite number of values and with the transition functions desired, according to principles of the present invention.

### DETAILED DESCRIPTION OF ILLUSTRATIVE EMBODIMENTS

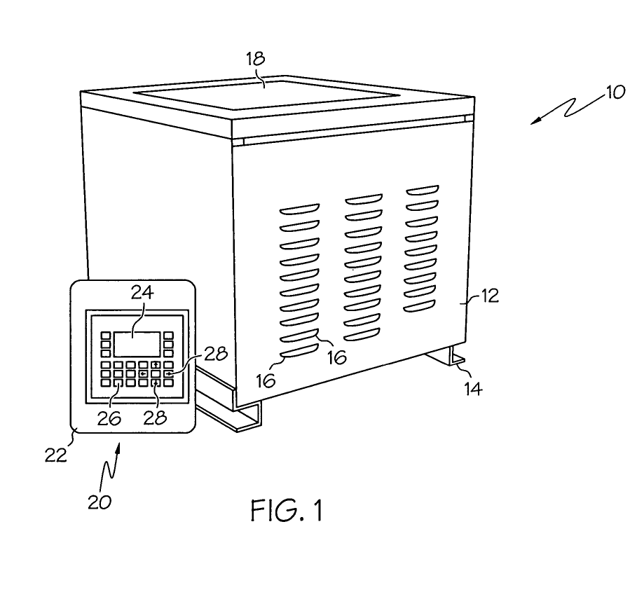

Embodiments of the present invention and their operation are hereinafter described in detail in connection with the examples of FIGS. 1-6, wherein like numbers indicate the same or corresponding elements throughout the figures. These embodiments are shown and described only for purposes of illustrating examples of components, systems, and methods that can be utilized to implement the principles of the invention, and should not be considered as limiting. From these examples, alternative systems, methods or components will be apparent to those of ordinary skill in the art and will be covered by the scope of the present invention.

FIG. 1 is a front perspective view of one illustrative load bank system, including a load bank unit along with its associated HMI programming and control unit, which are made and operate in accordance with principles of the present invention. In this embodiment, a load bank unit 10 is provided along with an HMI (Human Machine Interface) programming and control unit 20. The load bank unit 10 includes a housing 12, support feet 14, ventilation louvers 16, and a ventilation grid 18. The load bank unit 10 can be controlled and operated by the HMI programming and control unit 20. As will be described in further detail below with respect to various embodiments, the load bank unit 10 along with HMI unit 20 may be connected to virtually any electrical power system (e.g., a generator, uninterruptible power supply, or battery assembly) and can provide a controlled test load to the electrical power system. The test load may be varied to any of a substantially infinite variety of load conditions, manually or automatically, as will be described in further detail below. Accordingly, the performance of the electrical power system can be tested, observed, and/or exercised under various conditions that could be encountered during real operation under the actual load.

The HMI unit 20 can be programmed to enable an operator to control how much load is placed upon the electrical power system by the load bank unit 10 at any given time. In particular, the HMI unit 20 may include a microprocessor and/or other electronics that may be programmed to allow for input of parameters for setting up and adjusting the load that is presented, as well as for display and storage of data obtained during operation and relating to the testing conditions and the monitored performance of the electrical power system and/or the load bank system.

As shown in FIG. 1, the HMI control unit 20 can include a housing 22 which includes display 24 or other monitor, such as an LCD or the like. The control unit 20 is also shown to include input keys 26 for controlling the screens that are displayed, entering data and parameters, and providing other commands and configuration points for control of the load bank system of FIG. 1. In particular, a set of cursor control keys 28 may be provided to allow for navigation through the screens and data points. Other display and input devices can alternatively or additionally be incorporated into an exemplary control unit including, for example, one or more touchscreens, computer mice, indicator lights, buttons, keyboards, potentiometers, and the like, or combinations thereof. The control unit 20 can provide a control signal to the load bank unit 10 which adjusts the amount of resistance (e.g., load) presented by the load bank system upon the electrical power system. As will be described with respect to various embodiments below, this can occur via power electronics within the load bank system. These power electronics can be switched at high frequencies to thereby adjust the power flowing through resistors within the load bank unit, which accordingly adjusts the effective resistance of the load bank system upon the electrical power system being tested.

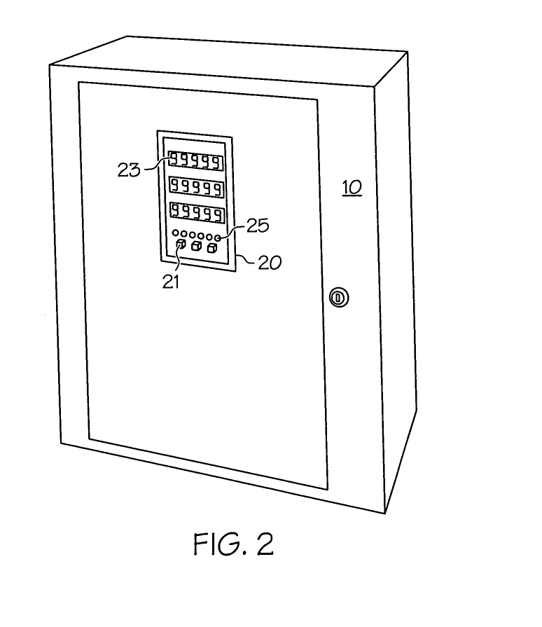

FIG. 2 illustrates an alternate embodiment of a load bank system in which the control unit 20 is integral with the load bank unit 10. Buttons 21 are provided to accept user inputs and a display 23 and indicator lights 25 are provided to display data to the user. This embodiment can similarly operate to provide a variable resistance upon electrical power system, such as according to the electronic control methods disclosed herein.

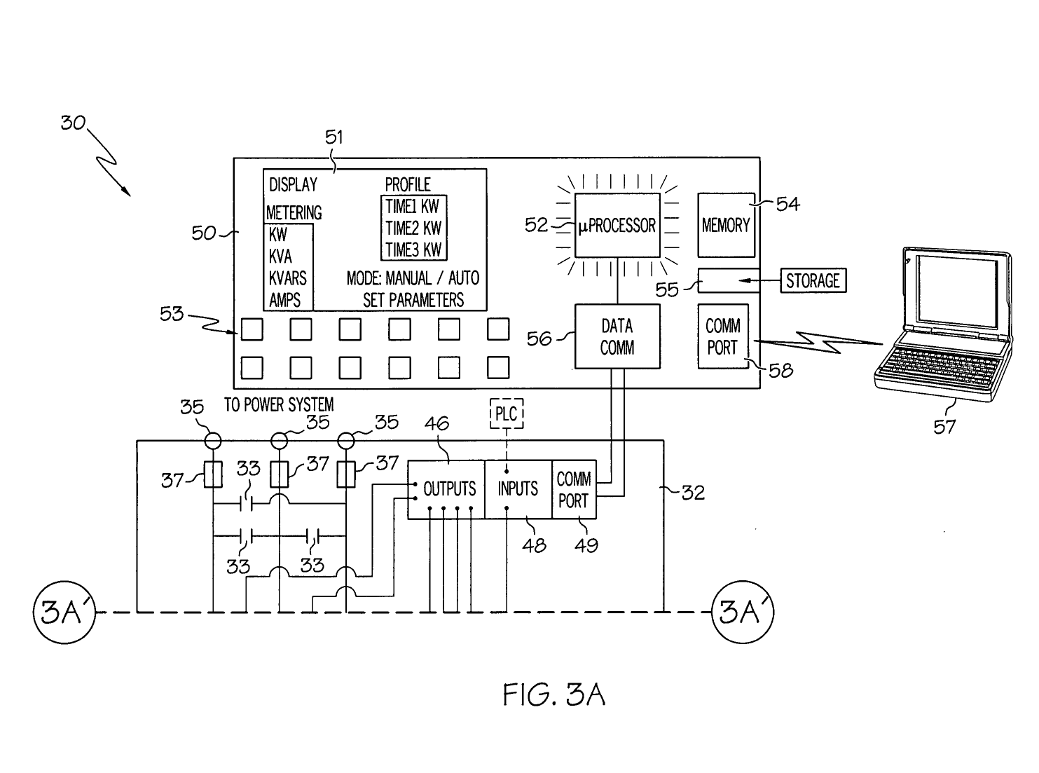

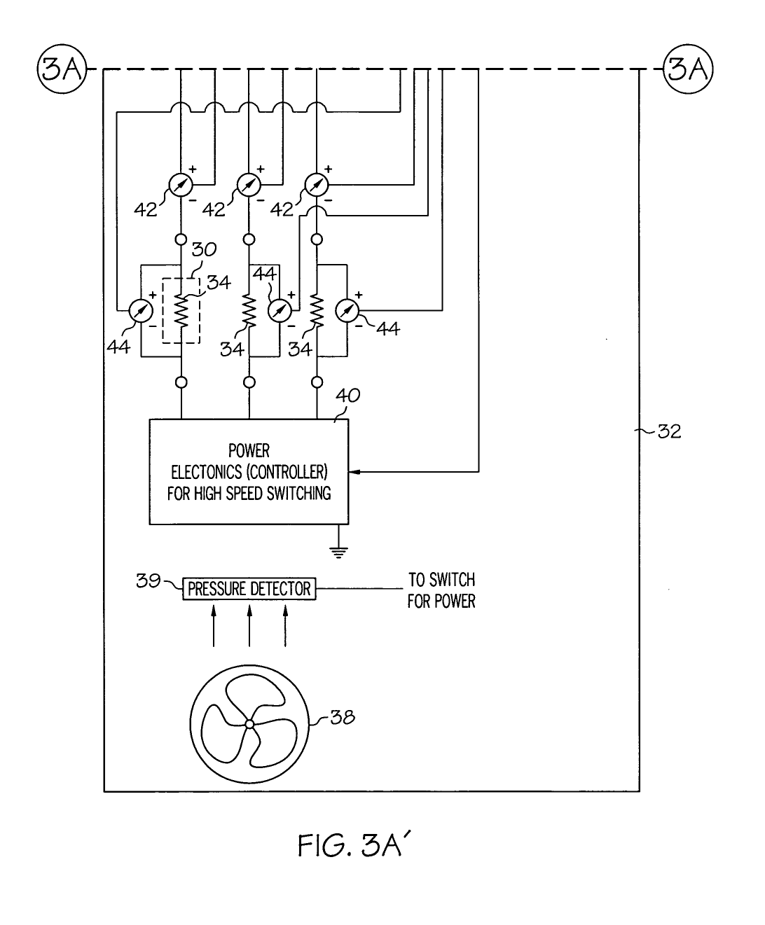

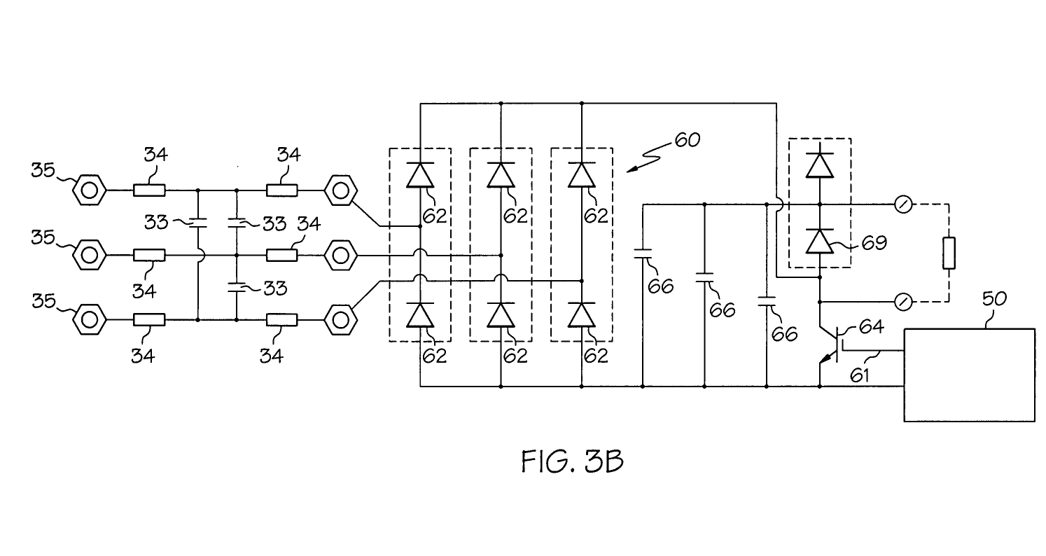

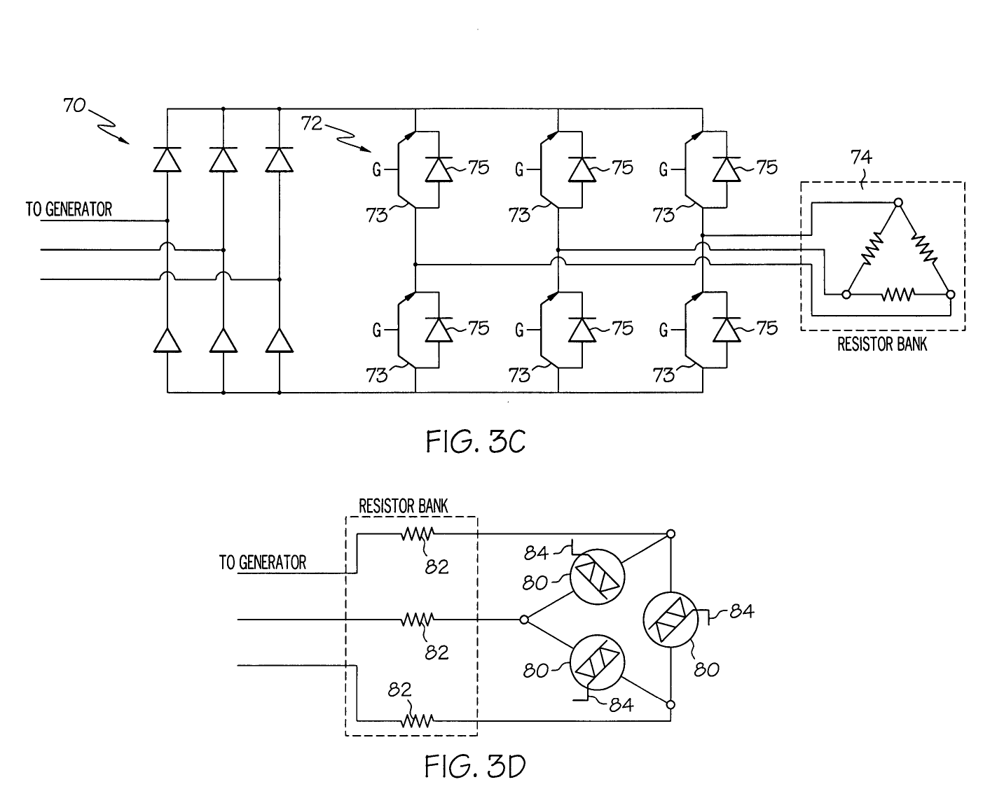

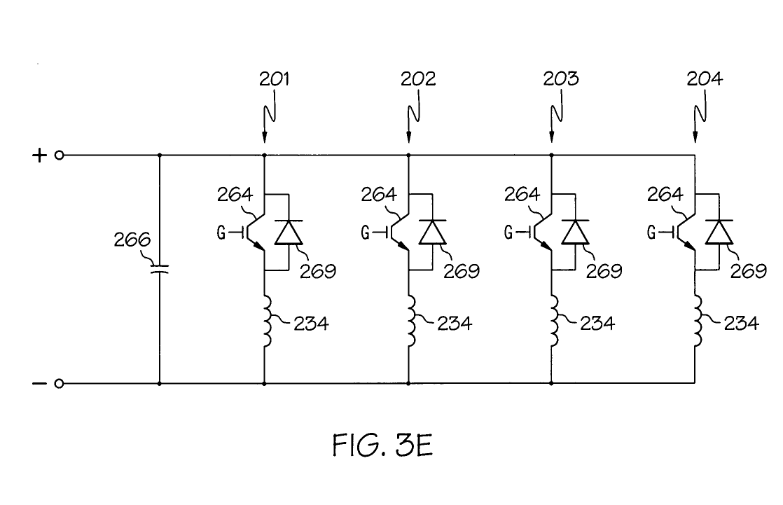

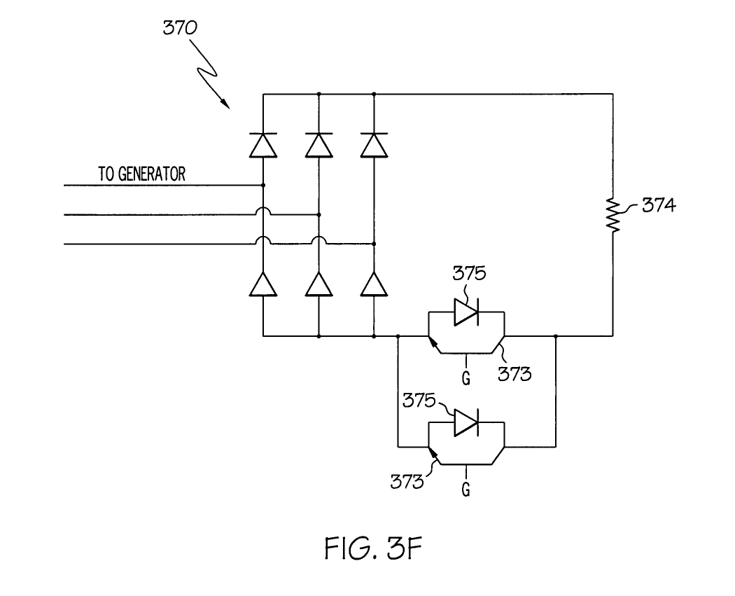

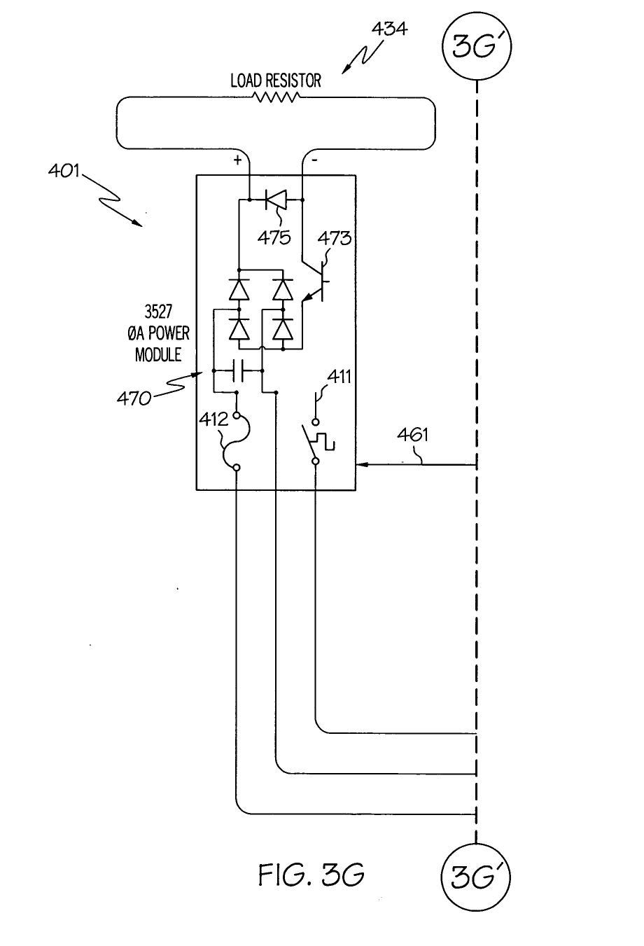

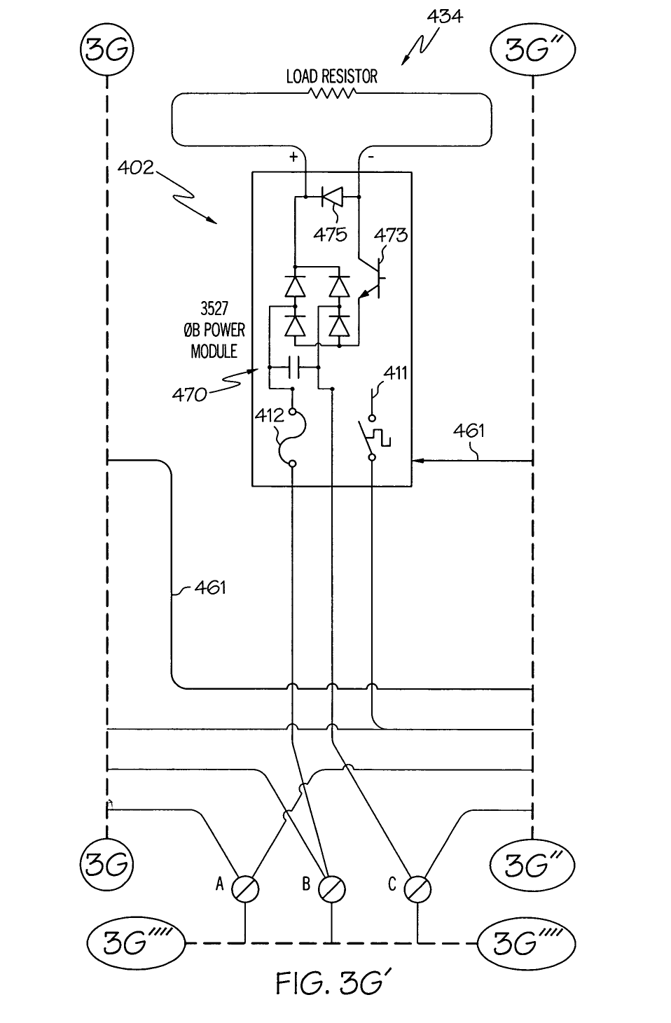

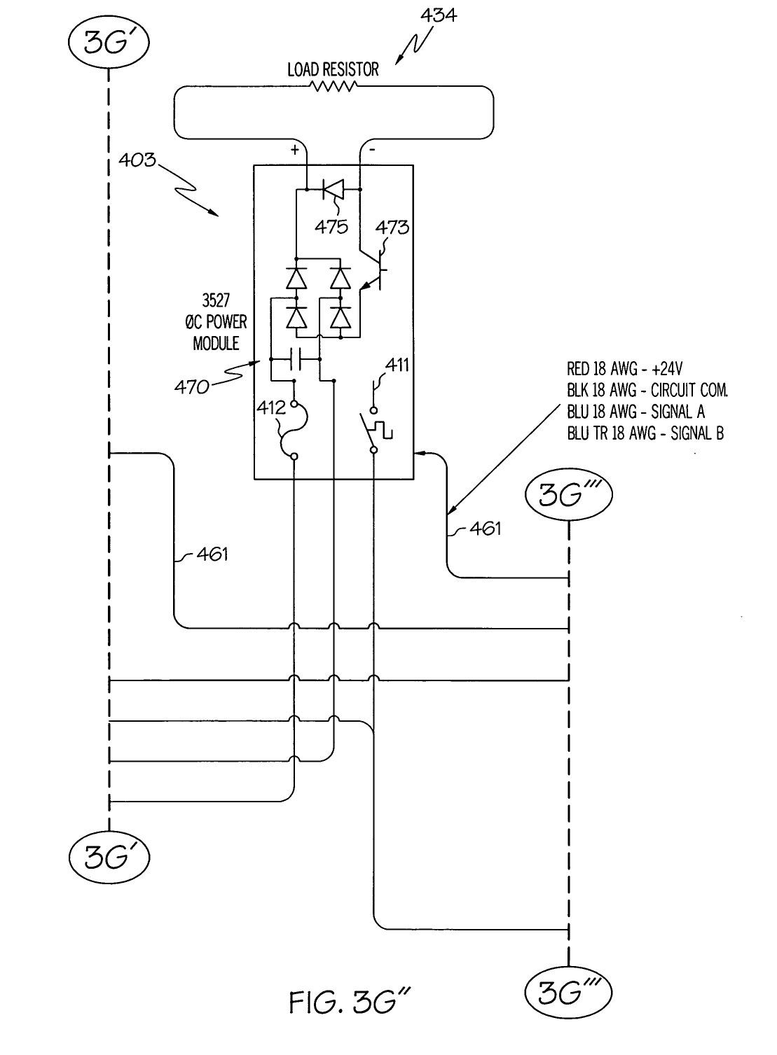

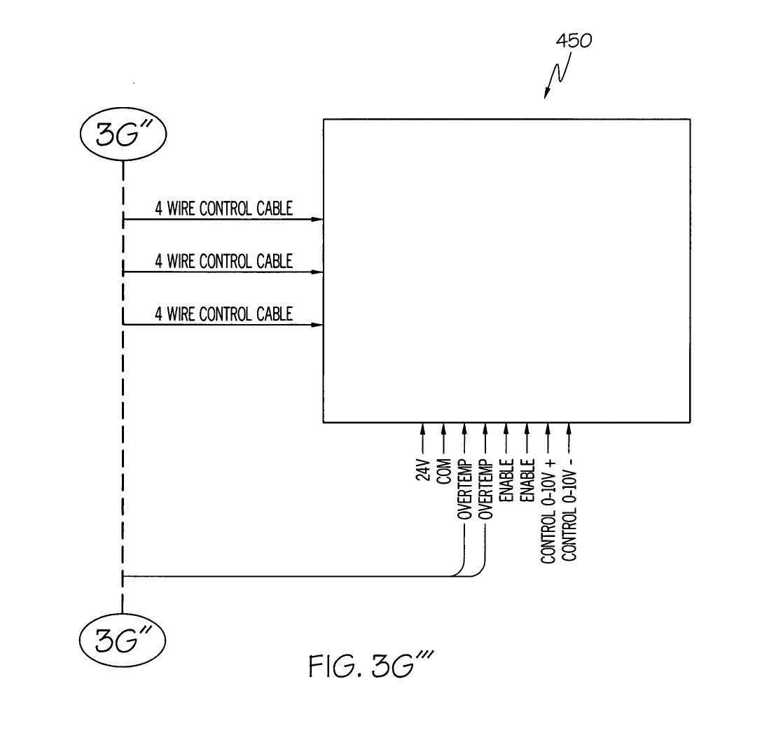

Another embodiment of a load bank system made and operating according to principles of the present invention is illustrated in FIG. 3a. In this embodiment, the load bank system 30 includes a load bank unit 32 and a control unit 50. The load bank unit 32 of this embodiment includes one or more power resistors 34, which are heavy duty resistors for carrying large currents, for each phase of incoming power. The incoming power is received by the load bank unit 32 at inputs 35. The resistors 34 can be provided in modular frames or housings 36 that can be easily mounted into the load bank unit 32 on racks or supports, so as to allow for ease of installation and modification. For cooling of the resistors 34, a fan assembly 38 can be provided. It should be understood that the fan assembly 38 can include one or more electrically powered fans, wherein the quantity, size and configuration of the fans will depend upon the number, size and configuration of resistors to be cooled, as well as the amount of power to be dissipated through the resistors. Certain embodiments of the present invention might not include a fan assembly, but might rather involve alternate cooling systems (e.g., liquid cooling) and/or might not require any cooling system whatsoever. When a fan assembly 38 is employed within an exemplary load bank system, a pressure detector 39 can be provided to monitor airflow from the fan assembly 38. The pressure detector 39 can be monitored by control circuitry within the load bank system. If the control circuitry senses from the pressure detector 39 that airflow is inadequate to sufficiently cool the resistors, the control circuitry can automatically disable the load bank system.

Other safety devices for protection of the exemplary load bank system can include fuses 37 or circuit breakers for providing over-current protection for both the load bank unit 32 and the electrical power system. In addition, capacitors 33 can be provided to smooth dissipate power transients (e.g., voltage spikes, current spikes, electrical noise) created by the high speed switching within the load bank unit 32 (to be described below). Also, metal oxide varistors (not shown) and/or other protective devices can be provided to help protect the load bank unit 32 against incoming voltage surges.

The load bank unit 32 can also include high speed switching electronics 40 provided in any of a variety of specific configurations. These high speed switching electronics 40 can be configured to vary the amount of time (e.g., duty cycle) during which current is allowed to flow through the resistors. By varying the duty cycle in this manner, the switching electronics can precisely control the amount of electrical power that is permitted to pass through the resistors 34, and can accordingly effectively vary the overall load presented by the load bank unit 32 upon an associated electrical power system (e.g., a generator). In this manner, a load bank unit 32 in accordance with principles of the present invention can effectively vary the loading upon an associated electrical power system without using such conventional techniques for achieving desired effective resistance as adding/removing individual resistors from a resistor bank in a stepwise manner and/or mechanically selecting certain resistors from a resistor bank. In other words, in this embodiment, a single constant resistance is provided (e.g., by one or more resistors), and that entire resistance is switched on and off from the electrical power source very rapidly, wherein the duty cycle of the switching determines the amount of power drawn from the electrical power source by the load bank system. Hence, the effective resistance reflected upon the power system under test by the load bank is varied accordingly.

FIGS. 3b-3g provide examples of circuitry which could provide such high speed switching electronics. In particular, FIG. 3b illustrates one configuration of high speed switching electronics that might be used within the electronic controller 40 of FIG. 3a in order to provide loading for a three phase AC source to be tested (e.g., an AC generator). In this embodiment, inputs 35 receive three phase power from the electrical power system and provide this power to the resistors 34. Capacitors 33 are provided for dissipation of power transients. A diode bridge rectifier circuit 60 includes diodes 62 to convert the three phase AC power to a single DC voltage.

A single IGBT (Insulated Gate Bipolar Transistor) power transistor 64 can be provided to then selectively switch the circuit from open to closed at a varying duty cycle and at a high rate of speed via a single control signal provided upon gate wire 61. Gate wire 61 can be driven by an oscillator circuit coupled with the control unit 50 (or an auxiliary PLC or controller). This high speed switching of the entire resistance into and out of the circuit via a single control signal is simple and efficient, particularly when compared to conventional load banks including many switching devices and associated control signals for selectively shorting out certain portions of resistors at various time intervals in order to selectively vary the effective loading upon the electrical power system. Additional circuitry can also be provided, as shown in this embodiment, such as capacitors 66, snubber resistor 68 and diode 69, all of which can be provided for signal conditioning and/or to dissipate power transients.

Use of IGBT's in such an arrangement has been found to allow for low switching losses, high gain, fast response and switching time, high current carrying capacity, small footprint, increased surge tolerance, less support circuitry, high energy efficiency, high reliability, fast switching capability, good PWM (pulse width modulation) capability, and/or the ability to easily use parallel transistors, particularly as compared to certain other technologies (e.g., SCR's). It should, however, be understood that any of a variety of other technologies might be employed in lieu of IGBT's in accordance with other aspects of the present invention, including for example BJT's, FET's, thyristors, triacs, diacs, SCR's and a host of other available fast-acting solid state power components.

Other embodiments of circuitry for high speed switching of the entire load into and out of the circuit are also possible. For example, FIGS. 3c and 3d illustrate examples of such circuitry that could be utilized as alternatives to the high speed switching configuration of FIG. 3b. In the example of FIG. 3c, a diode bridge rectifier 70 is provided to convert incoming three phase AC voltage (e.g., from a generator being tested) to DC. An inverter circuit 72 is provided to switch that DC voltage through the load resistor bank 74 in a timed and controlled manner, so as to produce the desired current waveforms in the load resistor bank 74. In this example, IGBT's or other transistors 73 are provided along with diodes 75. Control signals are provided to the gate G of each transistor 73, in order to provide the sequential switching of the transistors to thereby adjust the effective amount of power provided to the load resistor bank 74. In one embodiment, the control signals can be provided to the transistors by a microprocessor. The duty cycle (on versus off time) of the transistors affects the amount of power being passed to the load resistor bank 74, and the resultant load upon the electrical power system.

FIG. 3d illustrates another embodiment for providing high speed switching to vary the power consumed by a load bank system from an associated electrical power system. In this example, one side of a power resistor 82 is connected to each phase of an AC electrical power system to be tested. The other side of each of these power resistors 82 is then connected with triacs 80 connected in a delta configuration, as depicted in FIG. 3d. The triacs 80 then are switched at inputs 84 (e.g., by a microprocessor) in an ordered manner and at the desired duty cycle such that the overall effective resistance upon the electrical power system being tested is appropriate.

FIG. 3e illustrates yet another embodiment for providing high speed switching to vary the power consumed by a load bank system from an associated electrical power system. In particular, the circuit configuration of FIG. 3e is particularly suitable for association with a DC electrical power system, whereby the DC power is connected at the “+” and “−” depicted on FIG. 3e. The embodiment depicted in FIG. 3e includes four separate switching circuits 201, 202, 203 and 204. Each respective switching circuit can include a transistor 264, a diode 269, and a power resistor 234. When the transistor 264 is activated at its gate G, it will apply power to its associated resistor 234. The capacitor 266 and diodes 269 can assist in reducing power transients within the system. Although the gates G of the transistors 264 of all four switching circuits can all be switched at the same time in some embodiments, it should be appreciated that the transistors might be switched at different times from each other. For example, when simulating light loads on the associated electrical power system, only one of the transistors might be switched on and off, while the other transistors remain unswitched. Alternatively, the transistors might alternate such that the loading is evenly shared among the resistors. It should also be appreciated that the circuit could have fewer or more than four individual switching circuits (201, 202, 203, 204). By having multiple individual switching circuits as exemplified in FIG. 3e as opposed to a single switching circuit as exemplified for example in FIG. 3b, the load bank system can still function to provide some loading even if there is a partial system malfunction (e.g., one transistor fails). Also, it can be considerably less expensive to purchase four 100 Amp IGBT modules than it could be to purchase one 400 Amp IGBT module. Hence, such a configuration can offer some cost advantages.

FIG. 3f illustrates still another embodiment for providing high speed switching to vary the power consumed by a load bank system from an associated three phase AC electrical power system. In this embodiment, power from the electrical power system passes into the circuit through the bridge rectifier assembly 370 which converts the incoming three phase AC power to DC. The DC is then switched by one or more transistors 373 such that resistor 374 is powered whenever one or more such transistors 373 is/are turned on. Diodes 375 can be provided to help suppress power transients. When multiple transistors (e.g., IGBT's) are placed in parallel as shown in FIG. 3f, these transistors can either be switched on and off simultaneously via the same switching control signal (e.g., on gate G), or might alternatively be switched on and off at different times such as to achieve higher switching frequencies. For example, two IGBT's, each with a rating of 50 amps, could be connected in parallel and could have commonly driven gates operating with a 9 kHz switching (or carrier) frequency, and together could switch nearly 100 A. Alternatively, these same IGBT's could be connected in parallel and could have alternatively driven gates such that each operates with a 9 kHz carrier frequency. In such a case, the IGBT's could together switch nearly 50 amps, but could provide an effective 18 kHz switching frequency to the resistor 374. Regardless of whether one or more transistors are provided to switch power to the resistor 374, and regardless of whether one or both transistor gates are switched together, the power to the resistor 374 can be regulated thereby such that the amount of loading placed upon the electrical power system can be variably controlled as discussed above.

Turning now to FIG. 3g, a circuit diagram is depicted that includes three separate high speed electronic switching circuits 401, 402, and 403 configured for connection to a three phase AC electrical power supply. More particularly, switching circuit 401 connects across phases A and B of the incoming power supply, switching circuit 402 connects across phases B and C of the incoming power supply, and switching circuit 403 connects across phases A and C of the incoming power supply. Each of these switching circuits 401, 402 and 403 includes a power resistor 434 and a high speed switching transistor 473. Power enters each switching circuit 401, 402, 403 through a bridge rectifier section 470, selectively passes through the switching transistor 473 and is passed to the power resistor 434. A diode 475 can be provided to help eliminate potentially disruptive power transients. Each of the transistors 473 receives control signals instructing the transistor 473 when to open and close. The control signals can be passed to the transistors 473 through wires 461 leading to a control circuit 450. In one embodiment, each of these transistors 473 can be turned on and off at the same times. In another embodiment, however, the transistors 473 might be turned on and off at different times. In any event, the control circuit 450 can include a microprocessor, logic, or other electronic devices that operate the transistors 473 to achieve the appropriate duty cycle as commanded by an operator (e.g., at a control unit) or otherwise. The control circuit 450 may include a high speed PWM controller to command the high speed switching of the transistors 473. The control circuit 450 can also include one or more user adjustable components such as potentiometers, switches and the like that can be used by an operator to configure the control circuit with respect to the format of the input/output signals and/or with respect to the manner in which output signals are generated in response to input signals. Alternatively, the control circuit 450 can be configured to be user programmable in some other manner (e.g., with an external programmer), or can be factory preset without any user adjustment provision. The embodiment depicted in FIG. 3g is also shown to include current transformers 410 as monitoring devices, and to further include temperature sensors 411 and fuses 412 as safety devices. Signals from the current transformers 410 can be passed along to the control unit for display to an operator and/or might be monitored by the control circuit 450 to ensure proper operation of the load bank system or to adjust control signals. For example, if one of the phases fails as indicated by the current transformer signal, the control signals passed to the transistors can be modified as needed. Temperature sensors 411 can also provide signals to the control circuit 450 in order that the control circuit can disable the load bank system in the even that any of the transistors overheats. By switching transistors 473 on and off, the power to the resistors 374 can be regulated such that the amount of loading placed upon the electrical power system can be variably controlled as discussed above.

Although many exemplary circuit configurations have been presented in FIGS. 3b-3g, it should be appreciated that a variety of alternate circuit configurations could be provided to achieve the benefits as described above. Accordingly, with reference again to FIG. 3a, it should be understood that various power electronic circuits can be associated with the controller 40 for opening and closing the three phases at high speed, to thereby precisely control the amount of power dissipated by the resistors and the resultant load presented upon the system under test (e.g., a generator). Typical operational frequencies (e.g., switching or carrier frequency) of the IGBT's in such an application could be from about 2.0 kHz to about 15 kHz, although other frequencies are possible depending upon the specific type of IGBT and upon the specific voltages and currents to be switched. The duty cycle (on to off time) of the switching can vary from 0 to 100%, to thereby vary the power and the effective overall resistance by a corresponding amount. For example, a 60% duty cycle of an IGBT operating at a 10 kHz carrier frequency would mean that each cycle lasts 0.1 millisecond, and that for every 10 cycles of operation, the transistor is closed during 6 of the cycles and open during the other 4.

The embodiment of FIG. 3a also includes other components as well. For instance, one or more voltage sensors, current transducers, frequency sensors, temperature sensors, pressure transducers, power sensors, and/or any of a variety of other sensors or monitoring devices can be provided to monitor activity within an exemplary load bank. Any of these sensors or monitoring devices can provide feedback or monitoring information directly to one or more discrete panel-type display devices for visual indication to an operator, and/or to an associated control unit (e.g., an HMI). For example, as depicted in FIG. 3a, ammeters 42 and voltmeters 44 can be provided to monitor the current and the voltages of each power resistor. The outputs of such monitoring devices are shown, for example, as leading to an IO device such as an output board 46 in order that other devices can access the feedback information provided thereby.

Likewise, inputs for devices such as PLC's or computers can be provided at input board 48. In one embodiment, an input is provided to facilitate entry of a 0-10 volt analog signal (e.g., representing a duty cycle command) from a PLC, a potentiometer, or some other control device. Communication circuitry 49 can also be provided to allow for formatting, conditioning, and communication of the input and output information between the load bank unit 32 and the control unit 50. For example, communication circuitry 49 can include appropriate A/D and D/A converters, as well as a communication circuitry for exchanging the information with the control unit 50 in the appropriate format. In one embodiment, Ethernet communication protocol is utilized, along with appropriate ports and wiring. Also, the load bank unit 32 may include a microprocessor and related circuitry to provide the appropriate switching control signals to the power electronics 40 according to the duty cycle command received from the control unit 50 or from an auxiliary unit such as a programmable controller. (In certain embodiments, such as if the control unit 50 is made integral with the load bank unit 32, a single processor or other electronic circuit assembly may be utilized).

The control unit 50 (e.g., an Human Machine Interface or HMI) of this embodiment of FIG. 3a includes a microprocessor 52 and memory 54 including a software or firmware program which controls its operation. A corresponding data communication port and circuitry 56 is also provided for communication with the load bank unit 32. Other communication ports 58 may also be provided on the control unit 50, such as for communication with other devices, such as computers 57, printers, and the like. Storage devices and hardware 55 can also be provided on the control unit 50 to provide storage of data on removable or integral storage medium. The control unit 50 of this embodiment further includes a display 51 as well as user input keys 53 or related input devices to allow for communication of information to and from the user. In this example, the software in the unit 50 provides information on the display 51 for viewing of metering information (e.g., kW, KVA, KVARS, and AMPS), for establishing a load resistance profile (e.g. for entering the power to dissipate during various time periods), for changing between a manual and automatic mode, and for entering various configuration parameters related to the load bank system. Accordingly, the embodiment of FIG. 3a can provide ease of programmability and control of the load bank unit, substantially infinite variability of the effective resistance, advantages of digital and solid state electronics, and the ability to connect to various storage and peripheral devices.

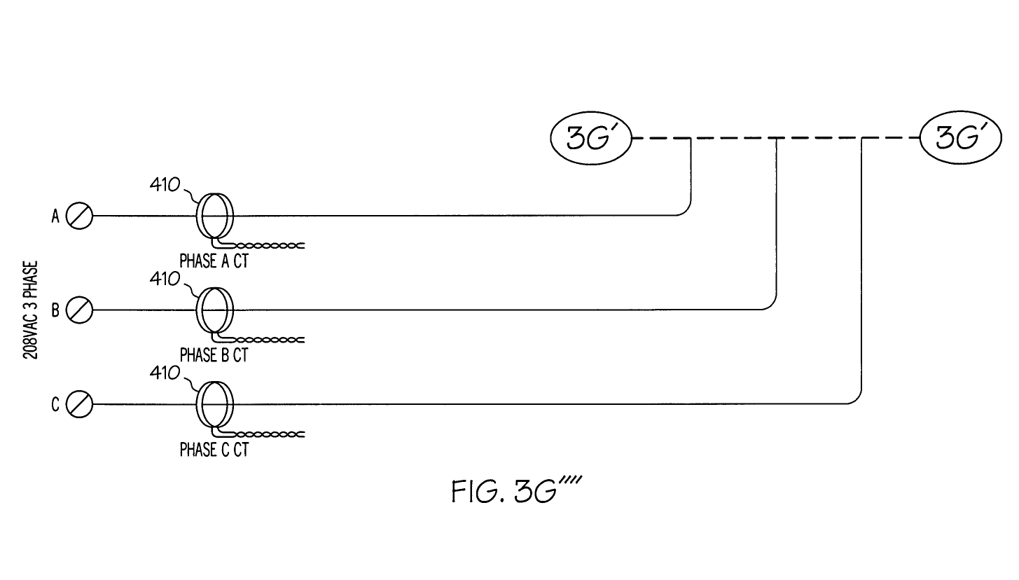

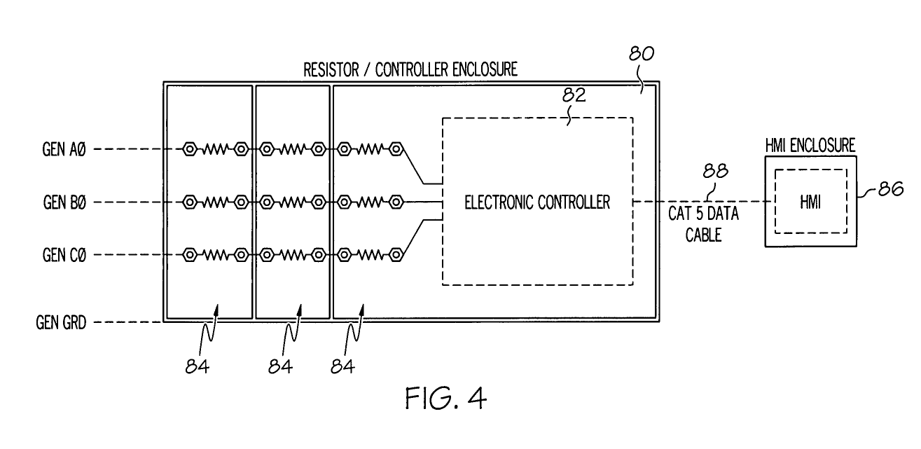

FIG. 4 illustrates another embodiment of a load bank system, which is made and operates according to principles of the present invention. In this embodiment, the load bank unit is provided as having a load bank (resistor/controller) enclosure 80. The bottom half of the load bank enclosure 80 houses the fan assembly (not shown) and electronic controller 82. The middle consists of the capacitors, PLC I/O module, and monitoring devices (not shown), such as those described above. The top half consists of snubber resistors (not shown) and modular load power resistors 84. In particular, a fan assembly resides at the bottom to force air upward across the resistors. An electronic controller 82 in the resistor/controller enclosure 80 receives three phase AC power from the load side of the load resistors 84 and chops the waveform to vary the passing power substantially infinitely from 0 to 100%. This controller can include the high speed switching circuitry described above, for example. A 0-10V signal from an HMI/PLC unit 86 regulates the electronic controller 82, which regulates the power consumption of the load bank system. Total Harmonic Distortion of less than 10% can be obtained for the unit in this embodiment, and can be improved for special applications. Capacitors can be used to smooth the power waveform and dissipate power transients created by the electronic controller. To reduce wiring between the resistor/controller unit and the HMI/PLC unit 86, an I/O module can be located in the resistor/controller enclosure 80 to receive all I/O's and transmit information to the HMI enclosure via a Cat 5 cable 88. It should of course be understood that any of a variety of other cabling or wireless systems can be used to associate a load bank unit with a control unit (e.g., an HMI).

Various metering devices can be used in the load bank unit to monitor the electrical parameters during testing and operation. For example, a standard unit may have current transformers and potential transformers to step down the current and voltage present at the load in order to monitor the current and voltage by appropriate meters or sensors. Moreover, snubber resistors may be provided near the fan assembly and used to dissipate power transients created by the electronic controller. Modular load resistors 84, for creating the desired load, can be stacked vertically above the snubber resistors and fan assembly, and bussed together. The load resistors 84 can be sized to dissipate 100% of the desired test load, and are switched between a connected and a disconnected state at very high speed by the electronic controller 82, as discussed herein. In this embodiment, the electronic controller 82 within the load bank enclosure 80 can have four standard ratings (125 kW, 250 kW, 500 kW, and 1000 kW), and the resistors 84 can have hundreds of standard ratings between 0-1000 kW. In an effort to reduce costs, the load resistors 84 may be designed to be modular. Hence, when a customer desires a particular power rating (e.g., 100 kW), the customer can be provided with a load bank having resistors closely matched to the specified power rating (e.g., 100 kW) and with the smallest available controller that can handle the power rating of the resistors (e.g., 125 kW). If after purchasing a 100 kW load bank the customer finds that additional loading will be necessary, the customer can at that time insert additional resistors, provided that the electronic controller's rating is not exceeded. Hence, in the above example, a customer could add an additional 25 kW of resistors to the 100 kW load bank, thereby creating a 125 kW load bank.

In one embodiment, a separate, small enclosure 86 is used to house the HMI control unit (e.g., HMI) for remote mounting, and a cable (e.g., one Cat 5 cable 88) is used to connect between the enclosures. The control unit can also be provided with power (e.g., 120V/20A). Provisions can also be installed on the resistor/controller enclosure 80 for mounting the control unit enclosure 86 on the side of enclosure 80. The control unit 86 can be a combination HMI/PLC unit that has the following features in one embodiment: supports I/O, Ethernet capability, RS232 or RS485 port, Nema 4, real-time clock, battery back-up, remote I/O, and onboard data logging. The user can use the control unit 86 to enter all data via the HMI input and display features, while a PLC (programmable logic controller) within the unit 86 controls all inputs and outputs. The enclosure for the control unit 86 can be mounted in a remote location, utilizing a single cable between the two enclosures 80 and 86, and 120V/20A circuit to the HMI.

Before operating the load bank system of this embodiment of FIG. 4, the user configures a program in the control unit 86 to match the desired load tests to be conducted. For example, the program can permit the user to enter the system voltage of the electrical system being connected in an initial configuration screen. In addition, the user can enter the configuration of the load bank (delta or wye), the power rating for the test, the number of data logs per minute and values to be logged (current, voltage, power, and frequency).

After the initial configuration screen, the user can then have a choice between manual and auto mode. When switching between modes, the load bank can be forced to disconnect by sending the appropriate signal to disconnect the resistors. If manual mode is selected, a manual mode screen can be provided on the HMI 86 to allow the user to scroll through the metering displays, set the desired power via keypad or up/down arrow keys, and start/stop the testing. If auto mode is selected, an auto mode screen can be provided on the HMI 86 to allow the user to set a complete load profile (a kW vs. time graph) by entering an unlimited number of data points (at time X, power is Y kW). Also, the user can select the type of transition (step or ramp) between data points, and start/stop the test. In particular, in auto mode, the user can be first requested to enter the number of data points in the profile. After a user enters the desired number of points, the display of the HMI 86 can then scroll one point at a time allowing the user to enter values. As the HMI 86 scrolls through each data point, the user is requested to enter the time and associated kW for each point. In addition, the user will be requested to enter the desired type of transition between each and every data point.

The load bank enclosure 80 can be provided with various meters for directly or indirectly monitoring the electrical performance of the electrical system and/or load. The meters can include an ammeter and voltmeter, with watts being calculated. However, a true wattmeter and frequency meter can be provided as well. The HMI 86 can integrate these metering functions, and in any event is provided with corresponding displays based upon the type of meters being utilized, which can be accessed by scrolling through the various displays user the user input buttons on the HMI. Alternatively, as previously indicated, discrete meters can be provided that are not associated with the HMI.

Various safety devices are also provided in this illustrative embodiment. For example, incoming fuses can be provided for over-current protection for the load bank and electrical system connected thereto. A pressure switch can also be used to detect low airflow (from the cooling fan for cooling the resistors) and activate a dry set of contacts. To protect the fan motor from damage, a motor overload switch can be installed.

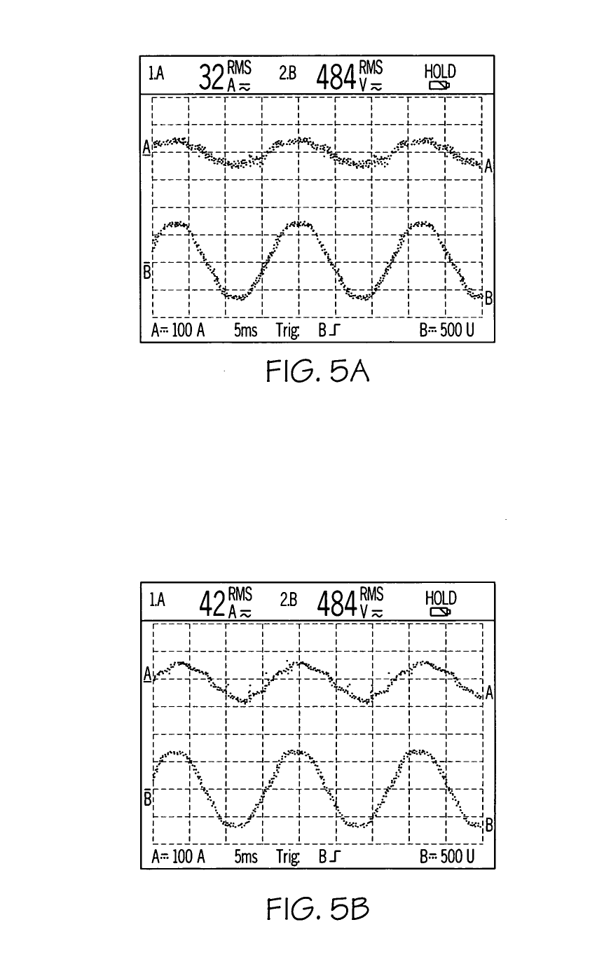

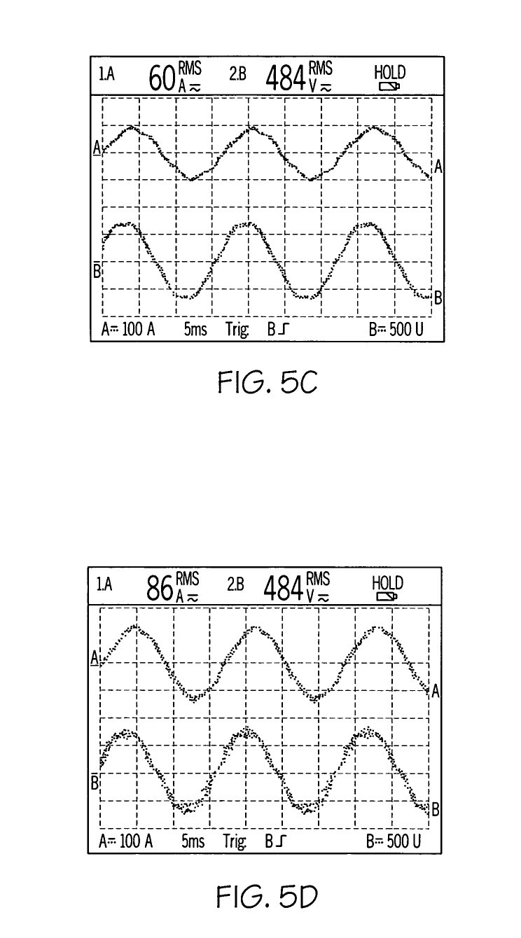

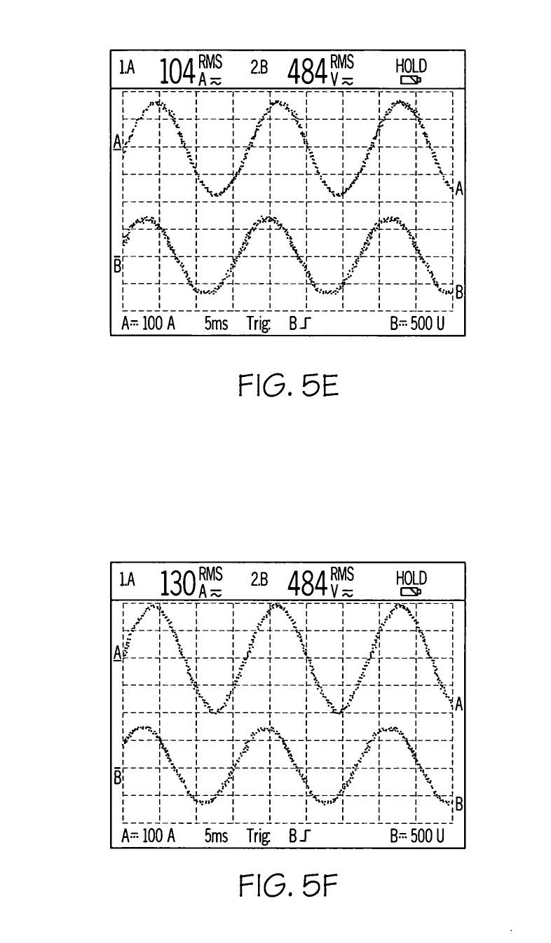

The plots of FIGS. 5a-5f are taken from a test of the embodiment of FIG. 4, using a 125 kW electronic controller in the load bank system, 100 kW resistors in the load bank system, and a 100 kW generator being tested. Generator current is waveform ‘A’ and generator voltage is waveform ‘B’. The same resistor bank (with a constant resistance) is employed within the load bank system for each of these tests. However, the effective resistance as experienced by the electrical power system is varied by the high speed switching of the load bank system, as described herein. Accordingly, by rapidly switching the resistance against the output of the generator, the effective resistive load encountered by the generator is, in effect, varied. In particular, as shown in these examples, the load power is varied from 21% to 28% to 40% to 57% to 70% to 87% of its maximum value. Thus, by modifying the switching timing and duty cycle of the electronic switches of the electronic controller 82, the resistance can be varied among a substantially infinite number of values between 0 and 100% of the total resistance of the resistor(s) in the load bank system. Such changes between loads can be made using a step function or a ramp function or other desired function, by utilizing the programmable microprocessor which provides the control signals to the switching electronics and which therefore can control the functions which define the transitions between the switching duty cycles.

Accordingly, in accordance with this and similar embodiments of the present invention, using solid-state control elements, the load bank allows a user to test a generator or power supply in a substantially infinitely variable number of steps. Any custom duty cycle curve can be programmed to simulate any actual operating condition. Data logging capability creates a record of performance that can be reviewed immediately after the test. The load bank system also assists in compliance with requirements of NFPA 70, NFPA 99 and NFPA 110 for testing of emergency power systems. This embodiment of FIG. 4 can provide a cost-effective option in which facilities can buy their own load banks and do the testing themselves. In addition, the portability and compact design of the load bank makes it easier to test uninterrupted power supplies, battery banks and distributed emergency power equipment. This load bank embodiment can work for 1 kW to 1000 kW applications and beyond. Because units can be modular, adding resistors permits expansion. Usually four basic sizes are available: 125 kW, 250 kW, 500 kW or 1000 kW, and the resistors have hundreds of standard ratings between 0-1000 kW. To be modular, when a facility asks for a specific power rating, the next higher rated electronic controller and the specified resistors to match the request can be selected. Since the resistors are modular in this embodiment, the facility can always install the remaining resistors (maximize electronic controllers rating) to add to the existing variable wattage load bank. For example, a 400 kW version is a 500 kW electronic controller with 400 kW resistors (since the generator is only 400 kW). To test a 500 kW generator, the user can then simply add a 100 kW resistor.

In this embodiment of FIG. 4, before operating the variable wattage load bank, the HMI 86 is first configured by the user to match the desired load tests by entering the system voltage, load connection (wye or delta), desired load rating, data log parameters (over 20 to select), and data log frequency. After configuration, the manual mode screen allows the user to scroll through the metering displays, set the desired power via the keypad or up/down arrow keys and start or stop the testing. The user can the select the appropriate digits for the desired powered, and hit enter, and the program will show the requested and actual kilowatts being monitored. Using the arrows or keypad, the user can move the desired power value up or down manually in real-time.

In the automatic mode of this embodiment, the user can program a complete load profile (a kW vs. time graph) by entering an unlimited number of data points (e.g., at time X seconds, power is Y kilowatts). Also, in this mode, the user can select the type of transition (step or ramp) between data points and start or stop the test. In particular, the user enters the desired number of points, and the Human Machine Interface 86 then scrolls one point at a time, allowing the user to enter the desired time and kW values for each data point. The user also enters the desired type of transition between each data point—e.g., a ramp or step in this embodiment. After programming the test profile using these data points, the user can save the profile in the memory of the HMI 86 for future use.

In this embodiment, the user can also download stored test procedures, profiles, and other data from a laptop of other digital computing device. Accordingly, the user can control the load bank from a web site or a plant computer in order to adjust the signal. Moreover, metering and other monitoring data can be transmitted to the computer for display and/or storage.

Moreover, the HMI 86 and/or the computer or PLC controlling the load bank can include a closed loop algorithm which adjusts the switching of the electronic controlling in order to maintain the power at the desired level. For example, as resistors heat up during testing, their resistance may change slightly. Accordingly, while a desired power rating may ordinarily translate to a certain switching duty cycle for initial testing, that duty cycle may become insufficient as the testing continues and the resistors become heated. Therefore, the measured power may drift from the desired power. However, a closed loop control algorithm can increase or decrease the duty cycle as such a drift begins to occur, to thereby maintain the desired power throughout the testing period.

In this embodiment, the remote mode allows the user to alternatively control the load bank via a 0-10V analog signal from a remote source (e.g., a PLC, a potentiometer, or some other control device), rather than from the HMI unit 86. This allows the user to maintain or vary a load on a load bus dependent upon other dynamic loads on the same bus. In other words, other loads and devices can be input to the PLC and the PLC can include a control program which supplies appropriate output signals for control of the load bank based upon the status of the other loads and devices. The metering and data logging capabilities of the HMI can still be used in such a mode. The load bank can be provided with a separate input for providing this analog signal from the PLC. Alternatively, the commands from the PLC can be provided over a common input which is also connected to the HMI.

Previously, conventional load banks needed to step up to reach the load required for the generator manufacturer burn-in. However, in this embodiment, the duty cycle of power electronics can be adjusted between various values substantially instantaneously, to cause a corresponding direct movement to the desired load. Thus, the user can program the electronics to go directly to the load level desired without any steps, which is desired because, when power outages occur, generators must often reach full capacity immediately. The user can also program such embodiments to kick on if a generator goes below a certain amount of load. Such variable wattage load banks can thus guarantee the performance of the electrical system by testing under such conditions.

Moreover, with this and similar embodiments, the user may test the electrical system in a variety of manners and under a variety of circumstances. In particular, a custom duty cycle curve can be programmed to simulate any actual operating condition, even those that are the closest possible to emergency situations. This digital technology allows for 100% capacity testing, in contrast to the plus or minus 10% capacity as with conventional units.

The data-logging capability of this embodiment creates a printed record of performance in real-time data output for review right after the test and for comparison to printable records from previous tests. Ammeter, voltmeter, wattmeter, and frequency metering capability can be provided, and additional metering can be provided as desired. Metering values can be accessed by scrolling through the meter displays on the HMI.

The control program in the HMI 86 of this embodiment can also assist in reaching compliance with NFPA 70, NFPA 99 and NFPA 110 for testing of emergency power systems with these new load banks. The program produces repeatable and accurate load cycles according to these standards, to verify that the generation capability meets these standards.

Thus, variable wattage load bank systems according to such embodiments can consist of two parts: the resistor/controller (load bank) enclosure 80 and the HMI enclosure 86. As discussed above, the user can have the option of remote mounting the HMI 86 using one Cat 5 cable 88 to connect between the enclosures. Another option is to mount it on the side of the resistor/controller enclosure 80. Safety features can also be provided such as incoming fuses which provide over-current protection for the variable load banks and the generators, and a pressure switch which can be used to detect low airflow and activate a dry set of contacts. To protect the motors (e.g., fan motors) from damage, a motor overload switch can be installed. The variable load bank of this embodiment can have less than 5% harmonics, and produce a sinusoidal waveform from 0 to 100% load.

Accordingly, a load bank system such as this embodiment is upgradeable, infinitely adjustable, fully programmable, provides recorded results, and can be remotely controlled. The digital controller within this embodiment enables the creation of new, more accurate and precise variable wattage load bank systems that can enhance the maintenance and testing of generators and power supplies. This comes at a time when the testing and maintaining of emergency power systems is critical, and at a time when constant Internet availability is impacting power requirements.

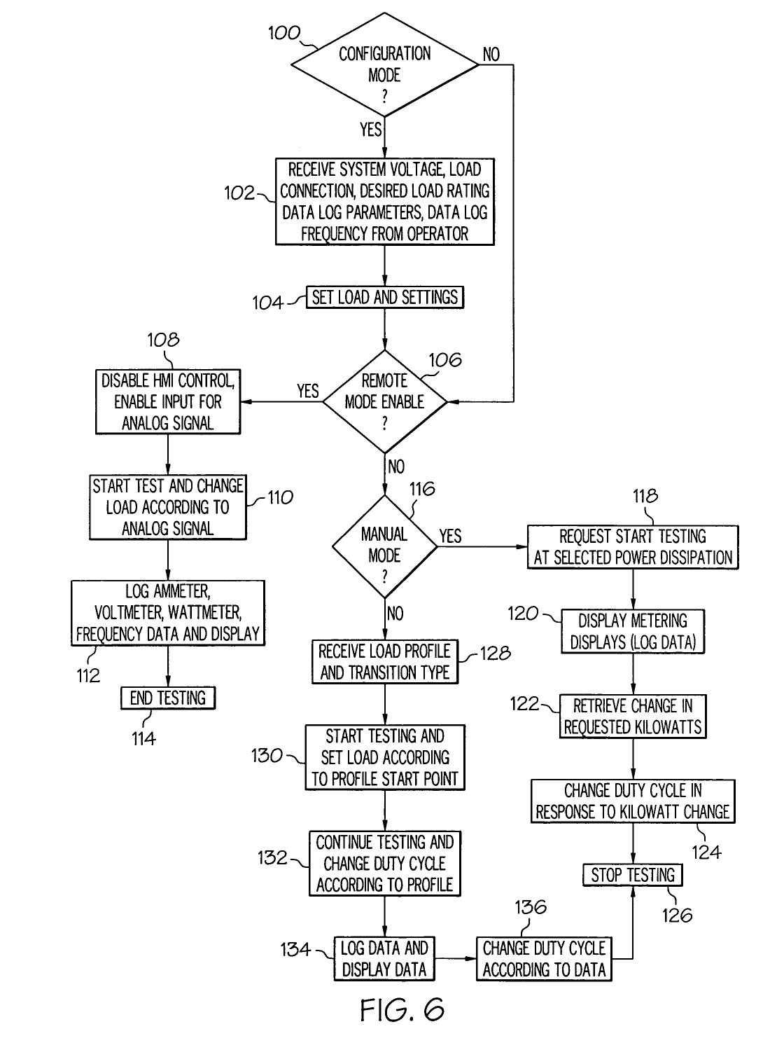

FIG. 6 is a flow diagram illustrating a software routine which may be operated by a load bank HMI control unit, a computer, or other programmable control unit or circuitry, according to principles of the present invention. As can be understood, the functionality of the routine and the other functionalities described herein can be implemented using software, firmware, and/or associated hardware circuitry for carrying out the desired tasks. For instance, the various functionalities described can be programmed as a series of instructions, code, or commands using general purpose or special purpose programming languages, and can be executed on one or more general purpose or special purpose computers, processors or other control circuitry.

According to this embodiment of FIG. 6, it is first determined at decision block 100 whether a configuration mode should be executed in order to receive configuration parameters for the load bank. This can be executed by a command from the user and/or at initial start up of the software. If configuration data is needed or desired, the parameters are received from the user as shown at block 102. For example, the user may supply the system voltage, the load connection type, the desired load rating, data log parameters to be obtained, and the data log frequency. Appropriate configurations of the load and settings can then be made based upon the data received, as shown at block 104.

Then, at decision block 106 it is determined whether the load bank is to be operated according to a remote input from a programmable logic controller or related auxiliary control device, or via a local input from the actual program of the HMI unit. If the remote mode is selected, then the HMI duty cycle control program is disabled and an input is enabled (either on the HMI or on the load bank) for receiving a duty cycle command from an auxiliary control device such as programmable logic controller. For example, the auxiliary control device may provide an analog 0 to 10 volt signal representative of the duty cycle desired (and thus the effective power dissipation desired; for example a 0 volt signal could represent 0% of the maximum power possible, a 5 volt signal could represent 50% of the maximum power possible, and a 10 volt signal could represent 100% of the maximum power possible).

Then, at block 110, the testing is started, such as by causing the switching of an appropriate switch to allow the power system to connect, and the effective load is controlled according to the analog signal provided from the auxiliary device. In particular, if high speed switching electronics are utilized, the duty cycle of the switching can be adjusted according to the voltage level of the analog input signal. For example, a 3 volt signal could result in a 30% duty cycle, a 5 volt signal could result in a 50% duty cycle, a 6 volt signal could result in a 60% duty cycle, a 6.11 volt signal could result in a 61.1% duty cycle, etc. As mentioned above, IO circuitry can receive the analog voltage signal, convert it to a digital value, and provide it to a microprocessor or digital controller which then controls the switching duty cycle based upon the voltage signal.

During the testing, various parameters can be monitored, such as from ammeters, voltmeters, wattmeters, and frequency monitors, and this data can be displayed on a display as shown at block 112. This data can also be used to adjust the desired power dissipation (e.g., if the desired power dissipation does not equal the actual monitored dissipation). For example, the analog signal can be increased or decreased based upon the monitored data in a closed loop manner in order to better achieve the desired power dissipation. After the testing via the analog signals is complete, the testing can then be stopped, as shown at block 114.

If the remote mode is not selected, then the process continues with a local mode of operation, which includes options to operate in a manual mode or an automatic mode. In particular, at decision block 116, it is determined whether the manual mode of operation has been selected. If so, at block 118, then desired power dissipation can be selected and the testing can be started, via appropriate user inputs and switching of the load bank in connection with the power system. During this manual mode, the monitoring data can be logged and displayed, as shown at block 120. In addition, at block 122, changes in the desired power dissipation can be received from the user, such as by using the display and user input devices. These changes are then implemented by the HMI unit by modifying the duty cycle in response to the power dissipation change, as shown at step 124, such as by providing a modified duty cycle command to the load bank unit resulting in a modified duty cycle control signal to the high speed switching electronics. Then, once the user has run the system manually at the various desired power dissipations, the testing can be ended, as shown at block 126.

As an alternative, an automatic mode can be selected at block 116 in which the load bank is operated according to a power profile. If this mode is selected, then the process continues to block 128 where a load profile is received from the user, by entering the various time periods and the power desired during each period, as well as the transition type to be made from one period to another (e.g., ramp function, step function, etc.) The load bank is then connected to the power system to start the testing, and the load (power dissipation) is set according to the initial point in the profile, as shown at block 130. This can be achieved by setting the appropriate duty cycle for controlling current through the resistors as has been described herein. The testing then continues and the duty cycle is automatically changed at the appropriate times according to the various data points in the profile, as shown at block 132. Data can be logged and displayed during the testing, as shown at block 134. In addition, it may be desirable to implement closed loop control to automatically modify the duty cycle according the parameters monitored. Once the testing has been completed according to the various power levels and time periods in the profile, the testing can cease, as shown at block 126.

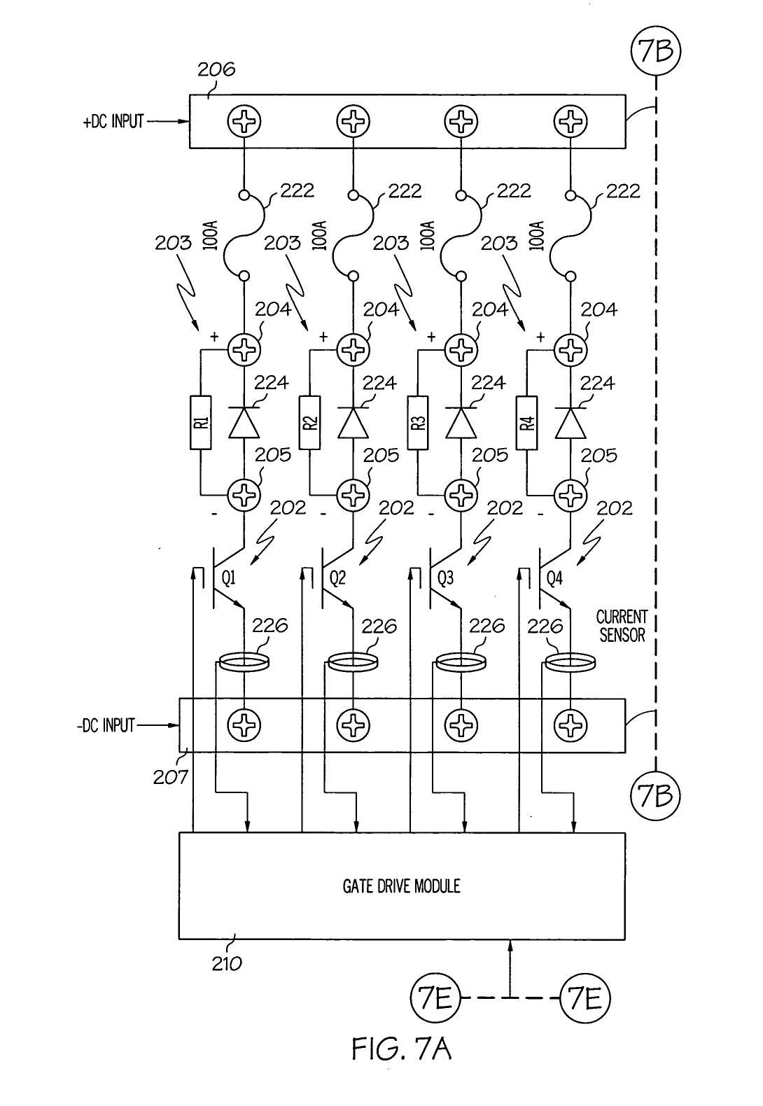

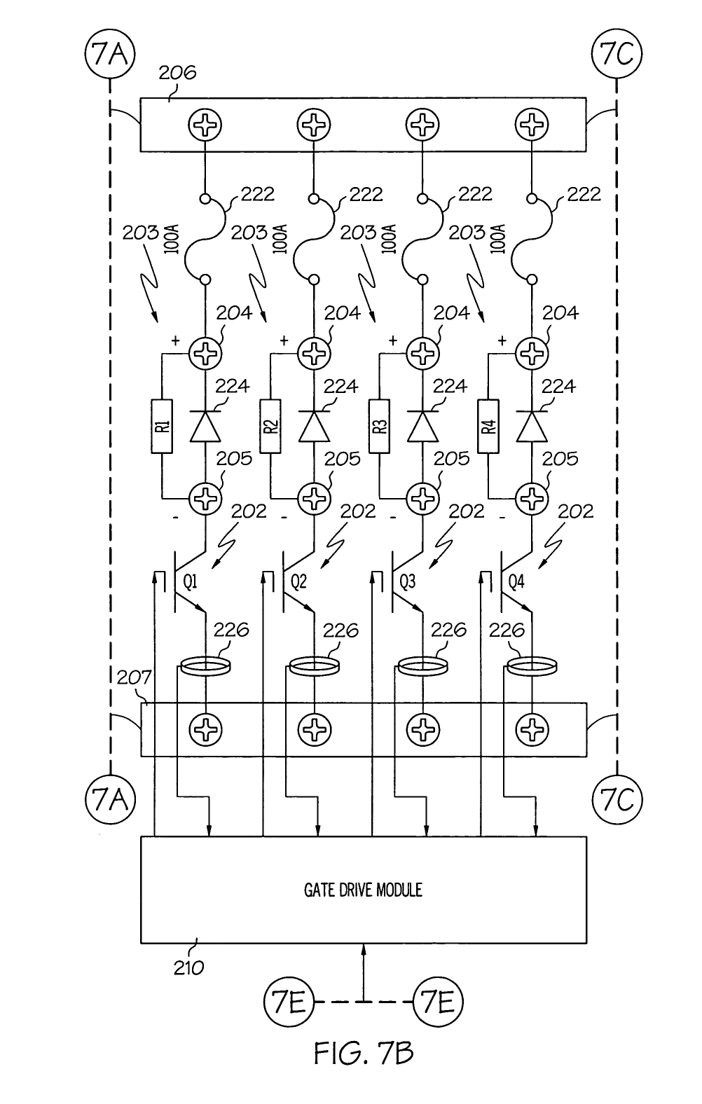

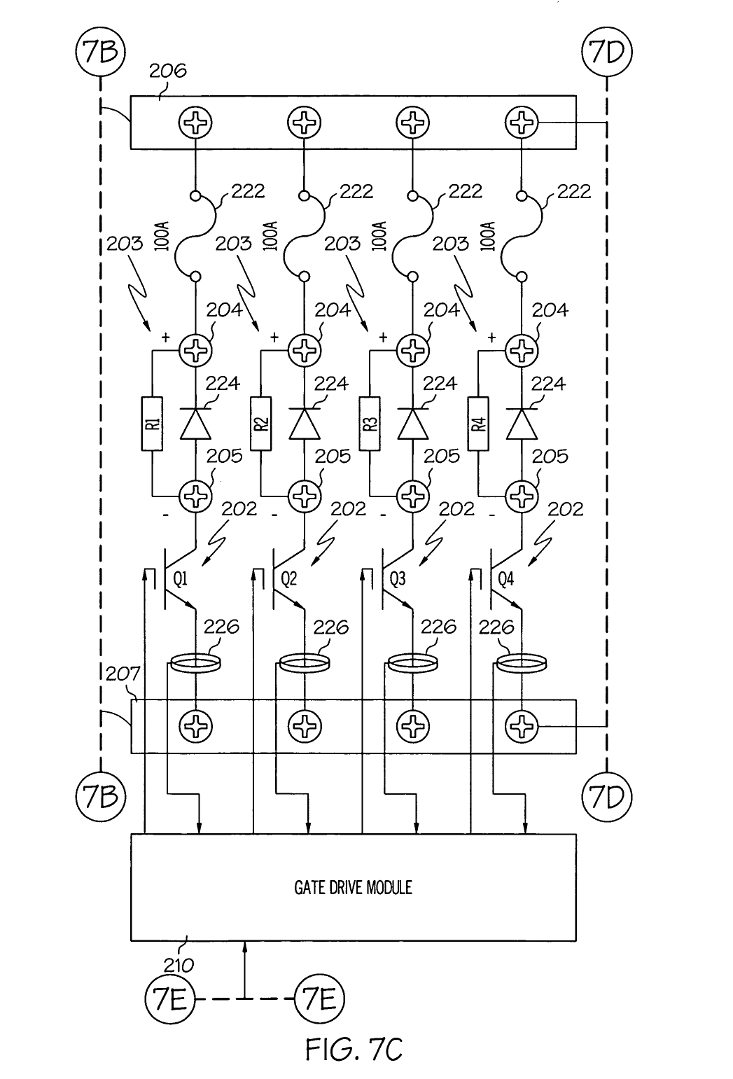

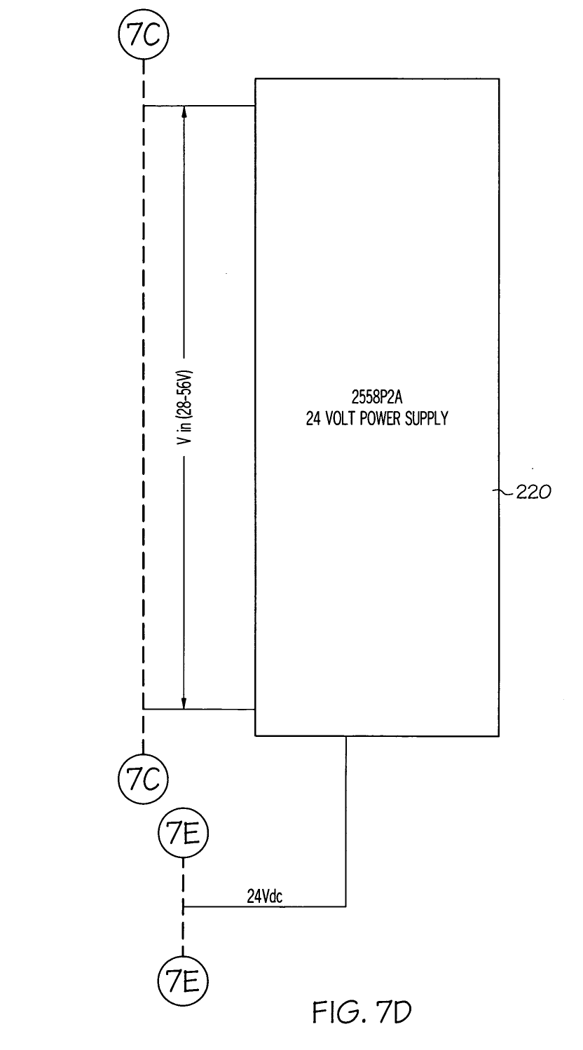

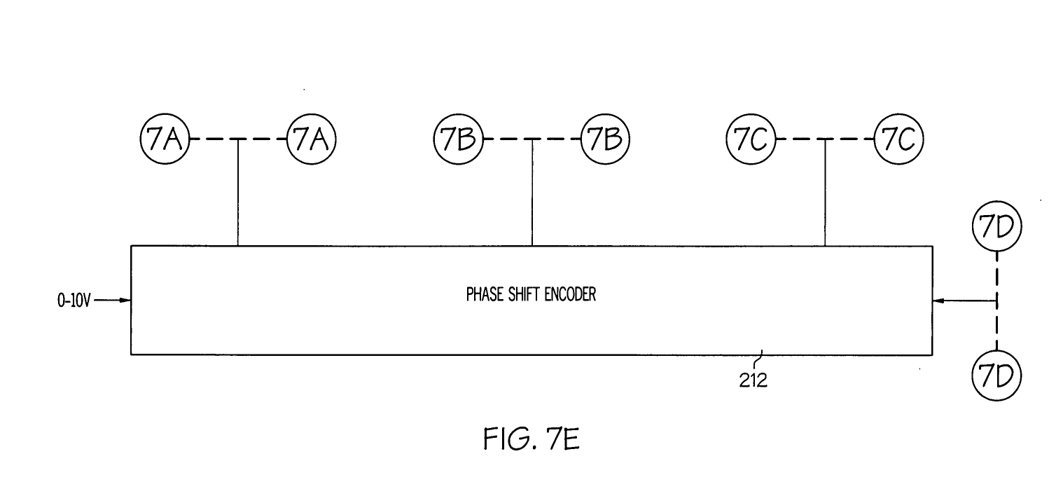

FIG. 7 is a schematic diagram illustrating another embodiment of a high speed switching circuit that can be utilized to electronically vary the effective load presented by load bank resistors to any of a substantially infinite number of values and with desired transition functions. According to this embodiment, transistors 202 are provided to switch on and off the flow of current through power resistors, at a high rate of speed. The power resistors (shown as R1 to R4) can be connected across terminals 204 and 205. By switching the transistors in this manner, the power resistors present an effective load to the power source being tested.

In particular, the power source being tested can be connected at terminals 206 and 207. This can comprise a DC power source or an AC power source whose power signal is first converted to DC by appropriate conversion circuitry (e.g., rectifier circuitry) before being provided to terminals 206 and 207. The transistors 202 can then switch the DC power on and off at a high rate of speed, such that the circuits 203 connecting terminals 206 and 207 are sequentially opened and closed. For each power resistor in a circuit 203, the amount of time that its associated transistor 202 is open versus the amount of time that it is closed determines the effective resistance presented by that resistor to the electrical power source. Accordingly, by varying this ratio, the effective resistance of the resistor can be varied, to a substantially infinite number of values.

To control the switching of the transistors, appropriate circuitry can be provided. In this example, three gate drive modules 210 are provided, each of which controls four circuits 203 that are each connected to the power source that is under test. Each power dissipation circuit 203 includes one transistor 202 and one corresponding power resistor R1, R2, R3, or R4. In the example of FIG. 7, transistors 202 can comprise IGBT's. The gate drive module 210 receives a command signal from a phase shift encoder 212 and provides the appropriate control signal to the gates of the transistors 202 to which it connects. The command signal could be indicative of the duty cycle desired for switching of the transistors 202. For example, an analog or digital signal could be provided to the phase shift encoder 212, such as from a controller or HMI unit, and this signal could be proportional to the effective resistance desired. The phase shift encoder 212 then converts this signal to the appropriate format for control of the gate drive modules 210 and then provides this converted signal as a command to the modules to switch the transistors at the proper duty cycle to achieve the desired effective resistance.

Other components can also be provided in the circuit of FIG. 7, as desired or appropriate for the application. For example, a power supply 220 can be provided to power the phase shift encoder 212. As shown in the embodiment of FIG. 7, the power supply 220 can receive its power through a connection to terminals 206 and 207, but power supply 220 could also receive its power from an alternative source. In addition, protection fuses 222 can be provided to protect the circuits 203 from overcurrent conditions (e.g., short circuits). Moreover, diodes 224 can be provided for noise suppression and/or dissipation of undersirable power transients resulting from the high-speed switching. Current sensors 226 can also be incorporated to monitor the current through each power dissipation circuit and such that the gate drive modules 210 or phase shift encoder 212 can verify that particular circuits 203 are operational (e.g., that a fuse is not blown, that a transistor has not failed and that the desired effective resistance is therefore being provided. If an error is detected (e.g., a fuse has blown or a transistor has failed) based upon the monitored current, adjustments can be made to the control signals for the still functioning circuits 203 to help compensate for failure of the non-working circuit. Also, the gate drive module 210 and/or phase shift encoder 212 might also provide an error signal to an operator for alerting the operator of the non-working circuit. While FIG. 7 provides one illustrative embodiment, other suitable components can also be utilized in the circuitry.

Many of the examples provided herein relate to the use of a load bank system with a DC electrical power system or with a three phase AC system. It should be appreciated, however, that aspects of the present invention can be used in conjunction with other electrical power systems.

The foregoing description of exemplary embodiments and examples of the invention has been presented for purposes of illustration and description. It is not intended to be exhaustive or to limit the invention to the forms described. Numerous modifications are possible in light of the above teachings. Some of those modifications have been discussed, and others will be understood by those skilled in the art. For example, although certain examples of components have been described, others may be chosen without departing from the scope of the invention. Likewise, various components, functionalities, and systems can be combined without departing from the scope of the invention. Accordingly, the embodiments were chosen and described in order to best illustrate the principles of the invention and various embodiments as are suited to the particular use contemplated. The scope of the invention is, of course, not limited to the examples or embodiments set forth herein, but can be employed in any number of applications and embodiments by those of ordinary skill in the art.

1. A load bank system, comprising:
a control circuit configured to provide a duty cycle command corresponding to a desired load;
an input configure to receive power from an electrical power system to be connected to the load bank system;
at least one power resistor selectively connected to the input; and
high speed solid state electronic switching circuitry configured to rapidly switch according to the duty cycle command from the control circuit in order to rapidly and sequentially permit current flow and prevent current flow from the input through the resistor according to the duty cycle command, to thereby modify the effective resistance presented to the electrical power system.

2. The load bank system as recited in claim 1, wherein the high speed solid state electronic switching circuitry includes at least one IGBT transistor.

3. The load bank system as recited in claim 2, wherein the load bank system further comprises:
a microprocessor configured with a program to provide control signals for control of the IBGT transistor according to the duty cycle command.

4. The load bank system as recited in claim 1, wherein the control circuit includes a programmable HMI unit.

5. The load bank system as recited in claim 4, wherein the HMI unit includes a display and input devices, and a program configured to allow a user to program a load profile to be presented by the load bank over time.

6. The load bank system as recited in claim 5, wherein the HMI unit includes a communication circuit for communicating with additional digital computing devices, and wherein the load bank system is configured to allow for inputs from devices other than the HMI unit.

7. The load bank system as recited in claim 1, wherein the electronic switching circuitry allows for a substantially infinite number of duty cycles and corresponding effective resistances.

8. The load bank system as recited in claim 1, further comprising:
a rectifier circuit connected between the input and the power resistor and configured to convert an AC power signal from the electrical power source to a DC power signal

9. A method for controlling and operating a load bank system comprising:
receiving a desired power dissipation value from a user;
providing a duty cycle command based upon the desired power dissipation value; and
rapidly switching according to the duty cycle command in order to rapidly and sequentially permit current flow and prevent current flow through power resistors of a load bank according to the duty cycle represented by the duty cycle command, to thereby modify the effective resistance presented to an electrical power source connected to the load bank.

10. The method as recited in claim 9, wherein the desired power dissipation value is received via a programmable HMI unit.

11. The method as recited in claim 10, wherein the duty cycle command is provided by a processor in the HMI unit.

12. The method as recited in claim 9, wherein an electronic switch is rapidly switched.

13. A load bank system, comprising:
an input configured to receive a duty cycle command signal from a programmable controller;
an HMI communication circuit configured for communication between load bank power electronics and a human machine interface terminal;
a power input configured to receive power from an electrical power system to be tested by the load bank system;
at least one power resistor configured for connection to the electrical power system to be tested; and
high speed solid state electronic switching circuitry configured to rapidly switch according to the duty cycle command signal from the programmable controller in order to rapidly and sequentially permit current flow and prevent current flow through the power resister according to the duty cycle represented by the duty cycle command signal, to thereby modify the effective resistance presented to the electrical power system.

14. The load bank system as recited in claim 13, wherein the high speed solid state electronic switching circuitry includes at least one IGBT transistor.

15. The load bank system as recited in claim 13, wherein the HMI communication circuit includes a communication port.

16. A computer implemented method for controlling and operating a load bank having power resistors by utilizing executable instructions, the method comprising:
receiving an input indicating whether remote or local mode of operation is selected;
if a local mode is selected, allowing for modification of a desired power dissipation through the load bank via a human machine interface unit and changing the current flow through the load bank power resistors based upon the modification; and
if a remote mode is selected, allowing for modification of the desired power dissipation through the load bank via an auxiliary controller unit and changing the current flow through the load bank power resistors based upon the modification.

17. The method as recited in claim 16, further comprising:
monitoring actual power dissipation and changing the current flow through the load bank power resistors based upon the difference between the actual power dissipation and the desired power dissipation.

18. A computer implemented method for controlling and operating a load bank utilizing executable instructions, the method comprising:
receiving configuration parameters for the load bank;
receiving an input indicating whether an automatic or manual mode of operation is desired;
if a manual mode input is received, allowing for modification of the desired power dissipation through the load bank and maintaining the effective resistance of the load bank according to the desired power dissipation until another modification of the desired power dissipation is received from the user; and
if an automatic mode input is received, allowing the user to configure a power profile indicative of the desired power dissipation through the load bank at multiple points in time and changing the effective resistance of the load bank at various points in time according to the power profile.

19. The method as recited in claim 18, wherein the effective resistance is maintained and changed by adjusting a duty cycle command.

20. The method as recited in claim 19, further comprising:
rapidly switching an electronic switch according to the duty cycle command in order to rapidly and sequentially permit full current flow and prevent current flow through resistors in the load bank, to thereby modify the effective resistance presented by the load bank.

21. A power source testing system, the system comprising:
an electrical power source;
a duty cycle control circuit configured to provide a duty cycle command signal based upon a desired effective resistance;
a gate drive circuit configured to provide a switching signal based upon the duty cycle command signal;
a power resistor;
an electronic switch configured to rapidly connect and disconnect the power resistor to the electrical power source according to the switching signal to thereby modify the effective resistance presented by the power resistor to the electrical power source.

22. The system as recited in claim 21, wherein the duty cycle control circuit comprises a phase shift encoder.

23. The system as recited in claim 21, further comprising:
a rectifier circuit configured to convert an AC power signal from the power source to a DC power signal.

24. The system as recited in claim 21, further comprising:
a programmable human machine interface configured to provide signals to the duty cycle control circuit.
